(19) United States
(12) Patent Application Publication
(10) Pub. No.: US 2018/0339600 A1
(43) Pub. Date: Nov. 29, 2018

(54) WIRELESS CHARGER FOR AN ELECTRIC VEHICLE

(71) Applicant: DIK CO., LTD., Chuncheon-si (KR)

(72) Inventor: Moon Soo KANG, Gimpo-si (KR)

(73) Assignee: DIK CO., LTD., Chuncheon-si (KR)

(21) Appl. No.: 15/984,205

(22) Filed: May 18, 2018

(30) Foreign Application Priority Data
May 25, 2017 (KR) 10-2017-0064663

(51) Int. Cl. B60L 11/18

(52) U.S. Cl. CPC B60L 11/1831; B60L 11/182; B60L 2200/18; B60L 11/1835; B60L 11/1825

(57) ABSTRACT

A wireless charger for an electric vehicle includes a feeder module supplying power by approaching a location of a collector module in the vehicle and a robot arm aligning a location of the feeder module according to the location of the collector module. A feeder inverter converts externally applied power and supplies the converted power to the feeder module. The wireless charger simplifies charging in various ways. The user does not need to connect to a charger each time a vehicle is to be charged. Since the user does not directly touch a charging connector in case rain, safety accidents can be prevented. A robot arm can transfer a feeder module according to a location of a vehicle parked within a charging station further enhancing convenience. Furthermore, a collector module installed in a vehicle is sensed and a feeder module is aligned according to a location of the sensed module.

Pursuant to 35 U.S.C. § 119(a), this application claims the benefit of earlier filing date and right of priority to Korean Application No.10-2017-0064663, filed on May 25, 2017, the contents of which are hereby incorporated by reference herein in their entirety.

### BACKGROUND OF THE INVENTION

### Field of the Invention

The present invention relates to a wireless charger for an electric vehicle. Although the present invention is suitable for a wide scope of applications, it is particularly suitable for charging a battery provided to an electric vehicle in a manner of connecting the battery by wireless.

### Discussion of the Related Art

Generally, a vehicle playing a role as a means essential to human life or social activities is a means of transportation using such fossil energy as petroleum as an energy source. Yet, fossil energy is a resource of limited reserves and is on the brink of being exhausted. Moreover, the price of the fossil energy is increasingly rising.

Particularly, while fossil energy is used, carbon dioxide working as a primary cause of global warming is massively discharged as well as various kinds of exhaust gases to contaminate an atmospheric environment. Therefore, to solve such problems, research and development for reducing the carbon dioxide emission quantity is globally making progress across all industrial fields. And, an electric vehicle that can move using electricity as an energy source has been developed as an alternative.

Electric vehicles are developed as a battery powered electric vehicle, a hybrid electric vehicle using both a motor and an engine, a fuel cell electric vehicle, etc. Moreover, in order to expand utilization and distribution of electric vehicles, it is necessary to establish a charging infrastructure that facilitates the charging anywhere and at anytime, which is researched and developed in various ways.

In order to charge such an electric vehicle, a charger is connected to a vehicle through a connector by wire.

However, since the battery capacity of an electric vehicle is being developed to increase day by day and a size and weight of wire for the wired connection are increased to charge a vehicle loaded with a high-capacity battery, it is inconvenient for a user to connect a heavy connector each time charging the battery.

### SUMMARY OF THE INVENTION

Accordingly, embodiments of the present invention are directed to a wireless charger for an electric vehicle that substantially obviates one or more problems due to limitations and disadvantages of the related art.

One object of the present invention is to provide a wireless charger for an electric vehicle, by which the user's inconvenience in connecting a charging connector can be resolved in a manner of changing a battery provided to an electric vehicle by wireless.

Another object of the present invention is to provide a wireless charger for an electric vehicle, by which a collector module of a vehicle having entered a charging station can be connected to a feeder module in a manner that a location of the collector module is automatically recognized.

Technical tasks obtainable from the present invention are non-limited by the above-mentioned technical tasks. And, other unmentioned technical tasks can be clearly understood from the following description by those having ordinary skill in the technical field to which the present invention pertains.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a wireless charger for an electric vehicle according to one embodiment of the present invention may include a feeder module supplying power by approaching a location of a collector module installed in the vehicle, a robot arm aligning a location of the feeder module according to the location of the collector module, and a feeder inverter converting an externally applied power, the feeder inverter supplying the converted power to the feeder module.

The robot arm may include a support part installed at a height set from an installation surface and a transfer part disposed to be movable on a top portion of the support part in a vertical or horizontal direction.

The transfer part may include a horizontal transfer member joined to a top end portion of the support part in the horizontal direction and a vertical transfer member joined to be transferable in the horizontal direction along the horizontal transfer member so as to transfer the feeder module in the vertical direction.

The transfer part may include a multi-rotation member rotated at a top end portion of the support part in the vertical direction and the horizontal direction and a vertical rotation member transferring the feeder module by being rotated at an end portion of the multi-rotation member in the vertical direction.

The robot arm may include a rotation part rotating the feeder module at an end portion of the transfer part so as to align the feeder module with the collector module side by side.

And, at least one of the feeder module and the robot arm may include a vision part obtaining a location of the collector module or sensing the feeder module to be aligned by responding to a direction of the collector module.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

Accordingly, embodiments of the present invention provide various effects and/or features.

First of all, since it is not necessary for a user to connect a connector connected to a charger each time an electric vehicle is charged, the charging can be facilitated.

Secondly, since it is not necessary for a user to directly touch a charging connector in case rain, an occurrence of a safety accident can be prevented.

Thirdly, as a robot arm can transfer a feeder module according to a location of a vehicle parked within a charging station, a charging location alignment can be done without stress.

Fourthly, since a collector module installed in a vehicle is sensed and a feeder module is aligned according to a location of the sensed module, it is able to expect an effect of a smoother charging.

Effects obtainable from the present invention may be non-limited by the above mentioned effect. And, other unmentioned effects can be clearly understood from the following description by those having ordinary skill in the technical field to which the present invention pertains.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a block diagram of a wireless charger for an electric vehicle according to the present invention;

FIG. 2 is a lateral view of a wireless charger for an electric vehicle according to a first embodiment of the present invention;

FIG. 3 is a lateral view of a wireless charger for an electric vehicle according to a second embodiment of the present invention; and

FIG. 4 and FIG. 5 are reference diagrams showing a state that a location of a feeder module of the wireless charger for the electric vehicle shown in FIG. 3 and a location of a collector module installed in the vehicle are aligned with each other.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. Moreover, in describing the present invention, if details of functions and/or configurations known to the public are determined as blurring the gist of the present invention unnecessarily, they will be omitted. Some features proposed in the drawings are enlarged, reduced or simplified for the facilitation of the description, and the drawings and the components therein are not always illustrated at the appropriate rates. Yet, such particulars can be easily understood by those skilled in the art, to which the present invention pertains.

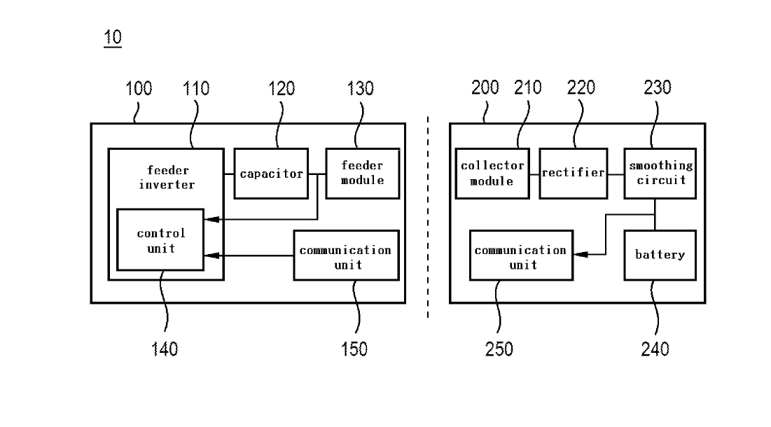

FIG. 1 is a block diagram of a wireless charger for an electric vehicle according to the present invention.

Referring to FIG. 1, a wireless charger 10 for an electric vehicle according to the present invention includes a feeder part 100 supplying a stable wireless power by converting an externally supplied power into a current or voltage to be supplied to a vehicle and a collector part 200 supplying a charging power by connecting a battery 240 connected to the vehicle to the feeder part 100 by wireless.

The feeder part 100 includes a feeder inverter 110 supplied with an external power, a capacitor 120 stabilizing a power supplied from the feeder inverter 110, a feeder module 130 supplying a wireless power by being disposed adjacent to the collector part 200, and a control unit 140 controlling them overall.

The control unit 140 also includes a communication unit 150 transceiving data for a charging state between the feeder part 100 and the collector part 200 by wired or wireless communication.

The collector part 200 includes a collector module 210 supplied with the outputted wireless power by being disposed adjacent to the feeder module 130, a rectifier 220 converting the power supplied to the collector module 210 into DC from AC, a smoothing circuit 230 reducing a pulsating portion of a rectified current supplied from the rectifier 220, and a battery 240 storing a power.

The collector part 200 also includes a communication unit 250 transmitting state data of the power, which is supplied to the battery 240 from the smoothing circuit 230, to the control unit 140.

Herein since the collector part 200 fails to have a separate control unit (not shown), it is able to minimize the facilities provided to the vehicle 1 by simplifying the configuration, whereby weight of the vehicle 1 is reduced to enhance fuel efficiency. Of course, the collector 200 can be controlled through the control unit 140 of the feeder part 100. And, a signal according to the control can be provided based on data supplied from each of the communication units 150 and 250.

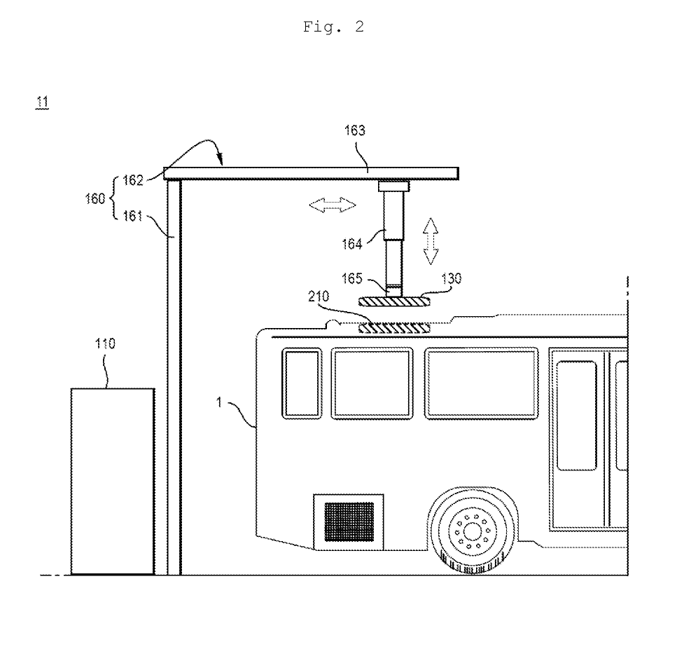

FIG. 2 is a lateral view of a wireless charger for an electric vehicle according to a first embodiment of the present invention.

Referring to FIG. 2, a wireless charger 11 for an electric vehicle according to a first embodiment of the present invention includes a robot arm 160 transferring a feeder module 130 provided to a collector module 210 provided to a vehicle 1. Described in the following is one example that the collector module 210 provided to the vehicle 1 is disposed on a top roof of the vehicle 1, by which a location of the collector module 210 is non-limited.

The robot arm 160 includes a support part 161 installed adjacent to a feeder inverter 110 at a prescribed height from an installation surface and a transfer part 162 disposed at a top end portion of the support part 161 in parallel with the installation surface to transfer the feeder module 130 in a horizontal or vertical direction.

The support part 161 connects a power line, which is supplied from the feeder inverter 110 and inserted in the support part 161, to the transfer part 162.

The transfer part 162 includes a horizontal transfer member disposed at the top end portion of the support part 161 in parallel with the installation surface and a vertical transfer member 164 transferring the feeder module 130 up and down in a vertical direction while transferring the feeder module 130 along a length direction of the horizontal transfer member 163.

The horizontal transfer member 163 is disposed to enable a horizontal movement on x- and y-axes in a horizontal direction from the top end portion of the support part 161. In doing so, the horizontal transfer member 163 is provided with a guide rail (not shown) on a bottom side so that the vertical transfer member 164 can transfer the feeder module 130 back and forth along the guide rail.

And, the vertical transfer member 164 transfers the feeder module 130 back and forth on the horizontal transfer member 163 in a top-bottom direction corresponding to the z-axis, thereby transferring the feeder module to be adjacent to the collector module 210.

Configuration of a rotation part 165 failing to be mentioned in FIG. 2 shall be described later.

Since the robot arm 160 of the wireless charger for the electric vehicle according to the first embodiment of the present invention does not have a change of the overall height, its configuration is simple to save the manufacturing cost. Therefore, the present invention is applicable to a company (e.g., taxi company, bus company, etc.) or person having a vehicle of a uniform overall height with low cost.

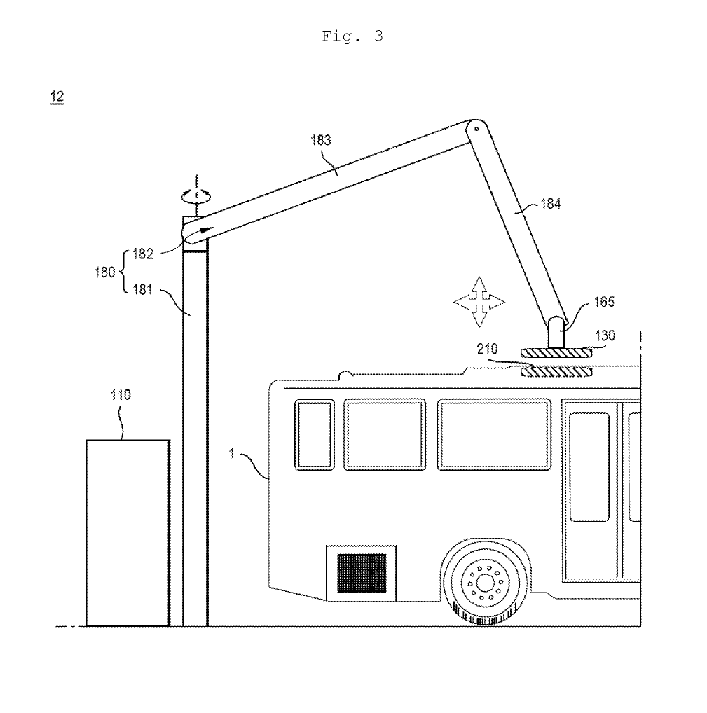

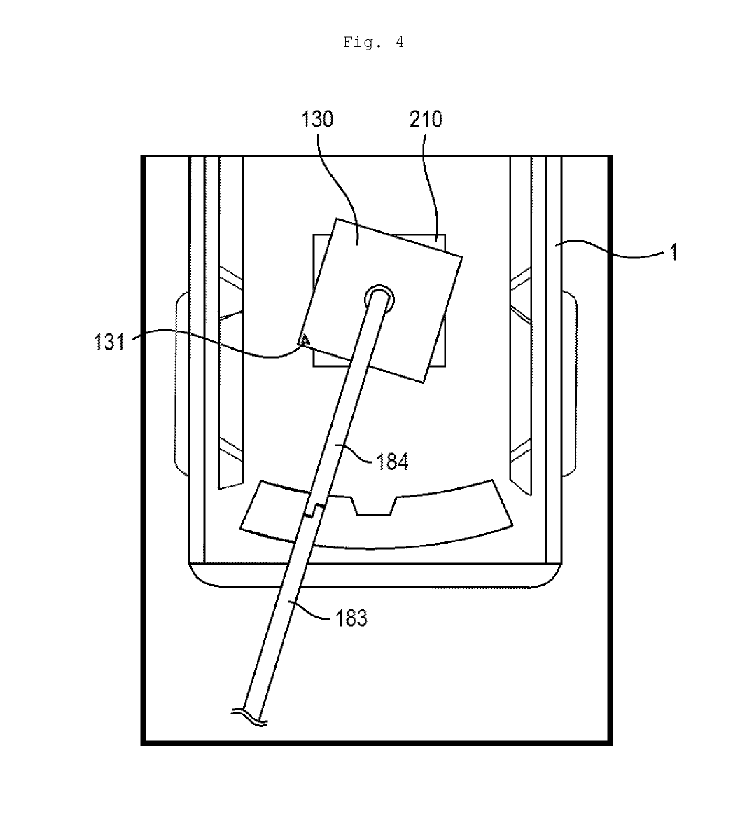

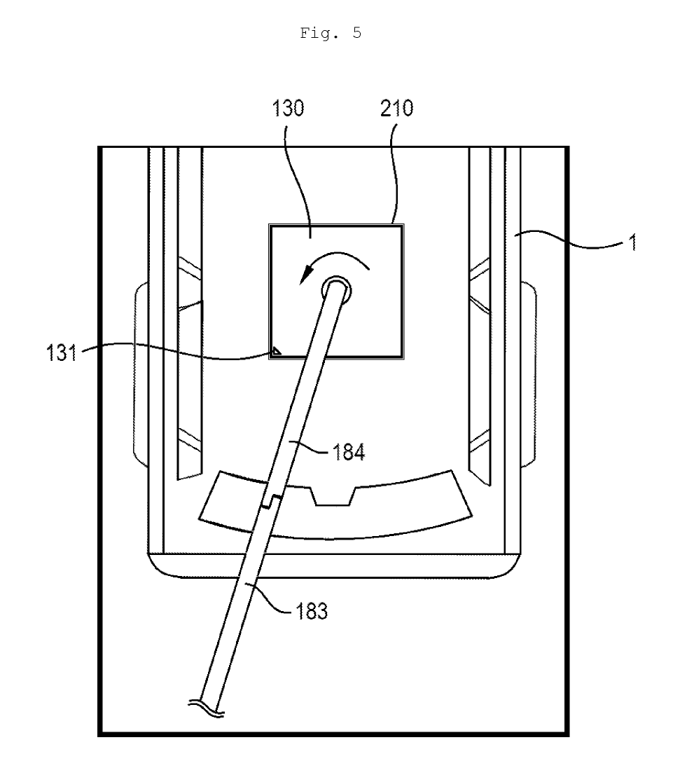

FIG. 3 is a lateral view of a wireless charger for an electric vehicle according to a second embodiment of the present invention, and FIG. 4 and FIG. 5 are reference diagrams showing a state that a location of a feeder module of the wireless charger for the electric vehicle shown in FIG. 3 and a location of a collector module installed in the vehicle are aligned with each other.

Referring to FIG. 3 and FIG. 4, a wireless charger 12 for an electric vehicle according to a second embodiment of the present invention includes a robot arm 180 transferring a feeder module 130. The same reference number as disclosed in the foregoing description refers to the same configuration. A collector module 210 provided to the vehicle is described as disposed on a top roof of the vehicle, by which a location of the collector module 210 is non-limited. For example, the location of the collector module 210 is applicable to a case of being disposed to a lateral, rear or bottom side of the vehicle.

The robot arm 180 includes a support part 181 and a transfer part 182.

Here, the transfer part 182 includes a multi-rotation member 183 rotating at the top end portion of the support part 181 in a vertical direction and a horizontal direction, a vertical rotation member 184 transferring the feeder module 130 by rotating at the end portion of the multi-rotation member 183 in a vertical direction, and a rotation part 165 rotating the feeder module 130 in a horizontal direction by being interposed between the vertical rotation member 184 and the feeder module 130.

The multi-rotation member 183 is joined in a manner that one end portion can be rotated at the top end portion of the support part in the horizontal direction. And, one end portion of the multi-rotation member 183 can be rotated in the vertical direction to change a height of the other end portion by being joined to the top end portion of the support part 181 by a hinge.

Moreover, the vertical rotation member 184 is connected to be rotated at the other end portion of the multi-rotation member 183.

Therefore, since the height of the feeder module 130 is changeable through the multi-rotation member 183 and the vertical rotation member 184, the feeder module 130 is easily applicable to vehicles in various heights at an expressway rest area or a public charging station.

When the vehicle 1 is parked at the correct position by centering alongside the support part 181, the rotation of the multi-rotation member 183 is not necessary. Yet, if the vehicle 1 is not parked at the right position, as the multi-rotation member 183 is rotated so that the feeder module 130 is rotated in the same direction, only if the feeder module 130 is rotated in a reverse direction, the feeder module 130 and the collector module 210 can come into contact with each other in an accurate direction. To this end, even if the vehicle 1 is parked cornerwise or parked side by side at a location deviating from the center of the support part 181, the rotation part 165 rotates the feeder module 130 so as to align the feeder module 130 and the collector module 210 at correct positions in forward direction.

For example, when the vehicle 1 enters a location by responding to the center of the support part 181, as the multi-rotation member 183 and the vertical rotation member 184 are rotated by responding to the height of the vehicle 1 without rotation of the multi-rotation member 183, the feeder module 130 and the collector module 210 are disposed adjacent to each other or come into contact with each other so as to perform the wireless charging. When the vehicle 1 enters a location deviating from the center of the support part 181, as the above process is performed after the multi-rotation member 183 has been rotated at a prescribed angle in the direction of the collector module 210, the feeder module 130 can find the way to the location of the collector module 130 accurately. Of course, if the rotation of the multi-rotation member 183 is performed, the rotation part 165 aligns the correct position by correcting the angle.

Here, if the vehicle 1 enters the location by responding to the center of the support part 181, it means that the vehicle 1 is parked in a state that a center position of the support part 181 and the center of the vehicle 1 are aligned with each other while entering a charging station. As the vehicle is aligned by a separate aligning means (not shown), the alignment between the feeder module 130 and the collector module 210 can be achieved more smoothly.

To at least one of the feeder module 130 and the robot arm 180, a vision part 131 is provided to obtain a location of the collector module 210 or sense the feeder module 130 to be aligned by responding to the direction of the collector module 210.

Referring to FIG. 4, the vehicle 1 is parked in parallel with a parking line L formed on a ground surface of the charging station. As the multi-rotation member 183 and the vertical rotation member 184 are rotated, the collector module 210 and the feeder module 130 are transferred to confront each other in vertical direction. In doing so, the vision part 131 senses a direction or location of the collector module 210 so that the feeder module 130 can be disposed in the correct position on the collector module 210. The location data of the collector module 210 sensed by the vision part 131 is provided to the control unit 140, whereby the feeder module 130 is rotated at a set angle through the rotation part 165.

Referring to FIG. 5, if the rotation part 165 rotates the feeder module 130 by receiving a control signal of the control unit 140, the feeder module 130 is located in place in a direction opposing the collector module 210.

The control unit 140 stores location data of the collector module 210 according to a type or size of the vehicle 1. Although the collector module 210 is located at other portions other than the top side of the vehicle 1, the control unit 140 may control the transfer or rotation of the robot arm 180 according to a location of the collector module 210 of the vehicle so that the collector module 210 and the feeder module 130 can be located in place [not shown in the drawing].

Accordingly, regarding a wireless charger for an electric vehicle according to the present invention, as a collector module and a feeder module are positioned to be adjacent to each other through a robot arm, a battery of a vehicle can be easily charged by wireless. Since the feeder module can be transferred and aligned by responding to a parked location of the vehicle or a location of the collector module, the charging can be performed more safely and efficiently.

It will be appreciated by those skilled in the art that various modifications and variations can be made in the present invention without departing from the spirit or scope of the inventions. Thus, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A wireless charger for an electric vehicle, comprising:
a feeder module supplying power by approaching a location of a collector module installed in the vehicle;
a robot arm aligning a location of the feeder module according to the location of the collector module; and
a feeder inverter converting an externally applied power, the feeder inverter supplying the converted power to the feeder module.

2. The wireless charger of claim 1, the robot arm, comprising:
a support part installed at a height set from an installation surface; and
a transfer part disposed to be movable on a top portion of the support part in a vertical or horizontal direction.

3. The wireless charger of claim 2, the transfer part, comprising:
a horizontal transfer member joined to a top end portion of the support part in the horizontal direction; and
a vertical transfer member joined to be transferable in the horizontal direction along the horizontal transfer member so as to transfer the feeder module in the vertical direction.

4. The wireless charger of claim 2, the transfer part, comprising:
a multi-rotation member rotated at a top end portion of the support part in the vertical direction and the horizontal direction; and
a vertical rotation member transferring the feeder module by being rotated at an end portion of the multi-rotation member in the vertical direction.

5. The wireless charger of claim 2, wherein the robot arm comprises a rotation part rotating the feeder module at an end portion of the transfer part so as to align the feeder module with the collector module side by side.

6. The wireless charger of claim 1, wherein at least one of the feeder module and the robot arm comprises a vision part obtaining a location of the collector module or sensing the feeder module to be aligned by responding to a direction of the collector module.
